(19) United States
(12) Patent Application Publication
(10) Pub. No.: US 2006/0216609 A1
(43) Pub. Date: Sep. 28, 2006

(54) Non-aqueous electrolyte battery and method for producing the same

(75) Inventors: Toshihiro Abe, Osaka (JP); Hayato Hicuchi, Osaka (JP); Hideaki Katayama, Osaka (JP)

Correspondence Address: BIRCH STEWART KOLASCH & BIRCH, PO BOX 747, FALLS CHURCH, VA, 22040-0747, US

(73) Assignee: Hitachi Maxell, LTD.

(21) Appl. No.: 11/385,689

(22) Filed: Mar. 22, 2006

(30) Foreign Application Priority Data
Mar. 23, 2005 (JP) 2005-082999

(51) Int. Cl. H01M 2/16; H01M 4/66; H01M 10/04

(52) U.S. Cl. 429/246; 429/245; 429/234; 29/623.5

(57) ABSTRACT

A non-aqueous electrolyte battery according to the present invention is a non-aqueous electrolyte battery including: a positive electrode including a positive collector and a positive active material containing layer formed on the positive collector; a negative electrode including a negative collector and a negative active material containing layer formed on the negative collector; and a separator provided between the positive electrode and the negative electrode. The positive electrode has a positive collector exposed portion at a part of the positive collector, on which the positive active material containing layer is not formed. An insulating resin film formed of a base substance of a heat resistant resin having a heat resistant temperature of 150° C. or more, the resin film containing a thermoplastic resin therein, is provided at a portion where the positive collector exposed portion and the negative active material containing layer are opposed to each other with the separator positioned therebetween.

### BACKGROUND OF THE INVENTION

1. Field of the Invention

The present invention relates to a non-aqueous electrolyte battery and a method for producing the same. In more detail, the invention relates to a non-aqueous electrolyte battery suitable for use as a power source for portable electronic devices, electric vehicles, load leveling systems, and the like, and a method for producing the same.

2. Description of Related Art

Lithium-ion secondary batteries, which are a kind of non-aqueous electrolyte batteries, have a high energy density, and thus have been used widely as a power source for portable devices such as a mobile phone and a notebook personal computer. Further, with due considerations to environmental issues, rechargeable secondary batteries are becoming more important, and they are considered for application not only to portable devices but also to automobiles, electric chairs, and power storage systems for household and business use.

Current lithium-ion secondary batteries are produced as follows. A positive electrode, a negative electrode, and a separator are wound into a cylindrical or flat shape to form a spiral winding body, which is inserted into a metal can of aluminum or stainless steel. Then, an electrolyte solution is injected into the metal can, followed by sealing. In order to prevent lithium that moves from the positive electrode to the negative electrode during charging from being precipitated in a metallic state, in general, a positive electrode sheet and a negative electrode sheet constituting the winding body are provided such that the negative electrode sheet is longer and wider than the opposed positive electrode sheet, and the separator for insulation is provided to have a large width.

For lithium-ion secondary batteries, a separator with a very small thickness of 20 μm or less is used so that the batteries have a higher capacity. Therefore, in the case where the separator has a scratch or is shifted when an abnormal impact is applied to a battery, the positive electrode and the negative electrode may be brought into contact with each other to cause a short circuit.

Due to relatively high electric resistance of a layer containing a positive active material (hereinafter, referred to as a “positive active material containing layer”), even when the negative electrode (a layer containing a negative active material (hereinafter, referred to as a “negative active material containing layer) or a negative collector”) is brought into contact with the positive active material containing layer due to a short circuit, a short circuit current and an amount of heat generated by the short circuit are small. However, since the negative active material containing layer has lower electric resistance than that of the positive electrode, a short circuit current and an amount of heat generation become large when the negative electrode is brought into contact with an exposed surface of a positive collector.

In a lithium-ion secondary battery, the exposed portion of the positive collector is provided so as to be opposed to the negative electrode at at least one of an end portion from which winding is started and an end portion at which winding is finished in the winding body. Accordingly, when a short circuit occurs at this portion, the battery is likely to be under abnormal conditions.

In order to avoid the above-mentioned problem at the portion where the exposed portion of the positive collector is opposed to the negative electrode, various methods have been proposed, such as a method (Japanese Patent Application No. 2004-259625 A) of forming an insulating layer of polyvinylidene fluoride or the like by the process of coating and drying or the like and a method (Japanese Patent Application No. 2004-63343 A) of forming an insulating coating film by binding heat resistant fine particles of aluminum or the like with a binder.

However, in the case where the insulating layer is formed only of a resin with high crystallinity such as polyvinylidene fluoride, when a coating liquid is dried, resin molecules are contracted, which leads to contraction of a coating film itself, resulting in decreased adhesion to current collector foil. As a result, the insulating layer is likely to be peeled off from the current collector foil. Further, in the case where the insulating coating film contains hard particles of aluminum, which somewhat contributes to the effect of suppressing contratgion of the coating film, the film becomes brittle. Thus, there still remains the problem of peeling-off of the insulating coating film. Such a phenomenon is seen particularly at an edge portion of the current collector foil, and thus an expected insulation effect cannot be achieved.

### SUMMARY OF THE INVENTION

The present invention was made in view of the foregoing problems, and it is an object of the present invention to improve the safety of a non-aqueous electrolyte battery by providing a stable insulating resin film between an exposed portion of a positive collector and a negative electrode.

A non-aqueous electrolyte battery according to the present invention includes: a positive electrode including a positive collector and a positive active material containing layer formed on the positive collector; a negative electrode including a negative collector and a negative active material containing layer formed on the negative collector; and a separator provided between the positive electrode and the negative electrode. The positive electrode has a positive collector exposed portion at a part of the positive collector, on which the positive active material containing layer is not formed. An insulating resin film formed of a base substance of a heat resistant resin having a heat resistant temperature of 150° C. or more, the resin film containing a thermoplastic resin therein, is provided at a portion where the positive collector exposed portion and the negative active material containing layer are opposed to each other with the separator positioned therebetween.

A method according to the present invention for producing a non-aqueous electrolyte battery including: a positive electrode including a positive collector, a positive active material containing layer formed on the positive collector, and a positive collector exposed portion at a part of the positive collector, on which the positive active material containing layer is not formed; a negative electrode including a negative collector and a negative active material containing layer formed on the negative collector; and a separator provided between the positive electrode and the negative electrode, includes: dissolving a heat resistant resin having a heat resistant temperature of 150° C. or more in a solvent to form a solution of the heat resistant resin in the solvent; dispersing a thermoplastic resin in the solution in which the heat resistant resin is dissolved to form a slurry; and applying the slurry to at least one of the positive collector exposed portion, the negative electrode, and the separator, followed by drying. An insulating resin film formed of a base substance of a heat resistant resin having a heat resistant temperature of 150° C. or more, the resin film containing a thermoplastic resin therein, is provided at a portion where the positive collector exposed portion and the negative active material containing layer are opposed to each other with the separator positioned therebetween.

According to the present invention, it is possible to prevent the occurrence of a short circuit between the positive collector exposed portion and the negative electrode, thereby providing a safer non-aqueous electrolyte battery.

### BRIEF DESCRIPTION OF THE DRAWINGS

FIG. 1 is a cross-sectional view of main portions of an exemplary winding body for use in a non-aqueous electrolyte battery of the present invention.

FIG. 2 is a cross-sectional view of main portions of another exemplary winding body for use in the non-aqueous electrolyte battery of the present invention.

FIG. 3 is an electron micrograph of a surface of an insulating resin film in Example 1 of the present invention.

FIG. 4 is an electron micrograph of a surface of an insulating resin film in Example 4 of the present invention.

### DETAILED DESCRIPTION OF THE INVENTION

In the present invention, an insulating resin film provided between a positive collector exposed portion and a negative active material containing layer is formed of a base substance of a heat resistant resin having a heat resistant temperature of 150° C. or more, and a thermoplastic resin is present therein. The heat resistant resin having a heat resistant temperature of 150° C. or more refers to a resin that does not melt, become softened, or deformed even when it is heated up to 150° C.

The heat resistant temperature of the heat resistant resin as a base substance is determined to be 150° C. or more so as to ensure that the film satisfactorily functions as the insulating film even at a high temperature and at least so as to ensure stability up to temperatures higher than a temperature (about 100° C. to 140° C.) at which the separator is shut down. By way of example, a heat resistant resin, such as those having a melting point of 150° C. or more may be used. Further, it is desirable that the heat resistant resin is excellent in insulation property, strength against a press, wear, and the like suffered when an electrode is wound, and strength against an impact applied when a battery is dropped, and is also excellent in stability toward a non-aqueous electrolyte.

As the heat resistant resin, those of high molecular weight having high crystallinity are desirable. Preferable examples include polyvinylidene fluoride and derivatives thereof, such as carboxylic acid-modified polyvinylidene fluoride and maleic acid-modified polyvinylidene fluoride, a vinylidene fluoride-hexafluoropropylene copolymer, an epoxy resin, a polyamide resin, and the like.

When a collector of an electrode is made of metal foil, the melting point of the heat resistant resin is set lower than that of the metal foil. As a result, in the case of welding a tab for current collection to the metal foil, even when the heat resistant resin is interposed between the tab and the metal foil, the tab can be welded to the metal foil by ultrasonic welding or the like while the heat resistant resin is melted.

The heat resistant resin that can be used is not limited to those having a high melting point as described above. Other resins whose melting point is not defined specifically can be used as long as they can exist stably up to a temperature of 150° C. or more. For example, resins having a softening point of 150° C. or more, such as a polysulfone resin, e.g., polyphenyl sulfone and polyether sulfone, and a polyimide resin, may be used.

When the insulating resin film is formed of the heat resistant resin, in general, the heat resistant resin is dissolved in a soluble solvent, and the solvent is applied to the collector or the like, followed by drying and removal of solvent. However, in the case of using a resin with high crystallinity as described above, which is prone to contract when the solvent is removed and has low plasticity, a problem is likely to occur whereby the resin film is peeled off from the object to which it is applied. To avoid this problem, in the present invention, a thermoplastic resin is provided in the insulating resin film formed of the heat resistant resin as a base substance to minimize contraction from occurring when the solvent is removed, and the film is provided with plasticity. In this manner, the durability of the insulating resin film is increased.

As the thermoplastic resin, a polyolefin resin such as polyethylene, polypropylene, and an ethylene-propylene copolyme, an ethylene-vinyl acetate copolymer, polymethyl methacrylate, an ethylene-methyl methacrylate copolymer, and derivatives thereof may be used preferably. In order to improve solvent resistance, those obtained by cross-linking a part of the above resins also may be used.

It is desirable that the thermoplastic resin is dispersed in the insulating resin film as uniformly and homogeneously as possible. For example, the insulating resin film desirably has a sea-island structure in which each thermoplastic resin particle is covered with the heat resistant resin. This makes it easier to achieve the effect of suppressing contraction and providing plasticity due to the thermoplastic resin while maintaining the film formation property and strength of the heat resistant resin.

It is preferable that the thermoplastic resin has a particle diameter smaller than the thickness of the insulating resin film. Specifically, the number-average particle diameter of the thermoplastic resin is preferably 0.1 to 50 μm, and more preferably not more than 30 μm. There is no particular limitation on the shape of the thermoplastic resin, and various shapes may be employed. However, in terms of uniform dispersion, a substantially spherical particle is preferred.

The thermoplastic resin is present in the insulating resin film in an amount of not less than 1 wt %. This makes it easier to achieve the effects of suppressing contraction and providing plasticity. The amount of thermoplastic resin present is preferably not less than 5 wt % to achieve higher plasticity. On the other hand, the thermoplastic resin is preferably present in an amount not more than 80 wt %, and more preferably not more than 50 wt % to improve the strength of the insulating resin film. Such wt % amounts are based on the total weight of the thermoplastic resin and the heat resistant resin.

The insulating resin film desirably has a small thickness in view of the thickness of a winding body. However, an insulating resin film that is too thin suffers a shortage of strength and loses its function as the insulating layer. On this account, the thickness of the insulating resin film is preferably not less than 5 μm and not more than 30 μm, and more preferably not less than 10 μm and not more than 20 μm.

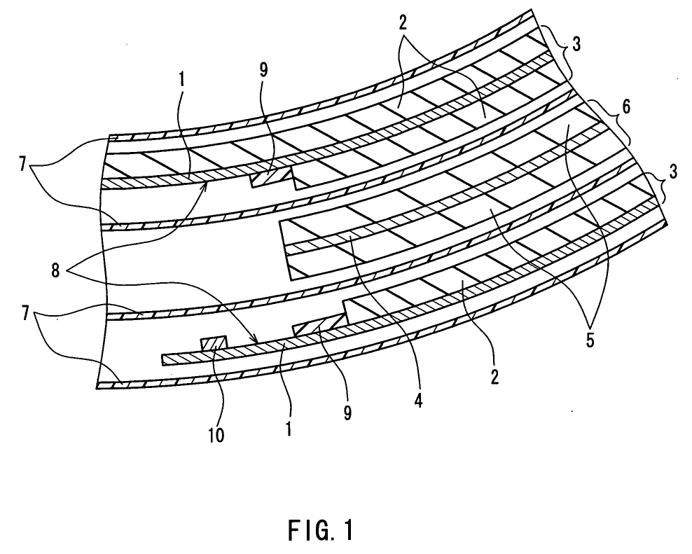

FIG. 1 is a cross-sectional view of main portions of an exemplary winding body for use in a non-aqueous electrolyte battery of the present invention. In FIG. 1, a positive electrode 3 includes a positive collector 1, a positive active material containing layer 2 formed on the positive collector 1, an exposed portion of the positive collector (hereinafter, referred to as a “positive collector exposed portion”) 8 provided at a part of the positive collector 1, on which the positive active material containing layer 2 is not formed. A negative electrode 6 includes a negative collector 4 and a negative active material containing layer 5 formed on the negative collector 4. A separator 7 is provided between the positive electrode 3 and the negative electrode 6.

At a portion where the positive collector exposed portion 8 is opposed to the negative active material containing layer 5 with the separator 7 therebetween, an insulating resin film 9 is provided on the positive collector exposed portion 8. Further, a positive electrode tab 10 is welded to the outermost positive collector exposed portion 8.

In the exemplary winding body shown in FIG. 1, the positive electrode 3 is located on the outermost side. In the outermost (first) positive electrode 3, the positive active material containing layer 2 is formed only on one surface of the positive collector 1. However, in the second and subsequent positive electrodes 3, the positive active material containing layer 2 is formed on both surfaces of the positive collector 1. In this winding body, an exposed portion of the negative collector (hereinafter, referred to as a “negative collector exposed portion”) is located on the innermost side of the negative electrode 6, which is not shown in FIG. 1.

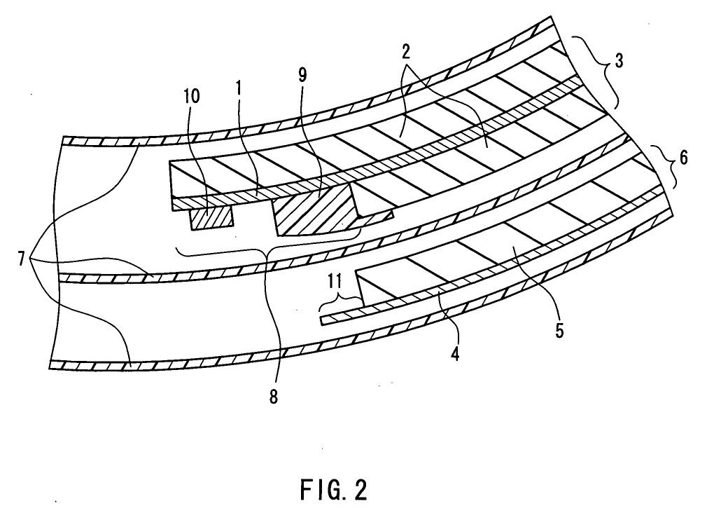

FIG. 2 is a cross-sectional view of main portions of another exemplary winding body for use in the non-aqueous electrolyte battery of the present invention. In FIG. 2, a positive electrode 3 includes a positive collector 1, a positive active material containing layer 2 formed on the positive collector 1, and a positive collector exposed portion 8 provided at a part of the positive collector 1, on which the positive active material containing layer 2 is not formed. A negative electrode 6 includes a negative collector 4, a negative active material containing layer 5 formed on the negative collector 4, and a negative collector exposed portion 11 provided at a part of the negative collector 4, on which the negative active material containing layer 5 is not formed. A separator 7 is provided between the positive electrode 3 and the negative electrode 6.

At a portion where the positive collector exposed portion 8 is opposed to the negative active material containing layer 5 with the separator 7 therebetween and the negative collector exposed portion 11 is opposed to the positive collector exposed portion 8 with the separator 7 therebetween, an insulating resin film 9 is provided on the positive collector exposed portion 8. Further, a positive electrode tab 10 is welded to the positive collector exposed portion 8.

In the exemplary winding body shown in FIG. 2, the negative electrode 6 is located on the outermost side. In the negative electrode 6, the negative active material containing layer 5 is formed only on one surface of the negative collector 4. In the positive electrode 3, the positive active material containing layer 2 is formed on both surfaces of the positive collector 1. Further, the insulating resin film 9 provided on the positive collector exposed portion 8 covers an end portion of the positive active material containing layer 2.

In the winding body in FIG. 2, the negative collector exposed portion 11 is formed at an end portion of the negative electrode 6 so as to be opposed to the positive collector exposed portion 8 with the separator 7 therebetween. In the structure in which the negative collector exposed portion and the positive collector exposed portion are opposed to each other, there is a danger that a short circuit occurs at the portion where these exposed portions are opposed to each other. If a short circuit occurs between the exposed portions, a higher electric current flows than in the case where a short circuit occurs between the negative active material containing layer and the positive collector exposed portion, and accordingly a large amount of heat is generated. As a result, a battery is likely to be under dangerous conditions. However, as shown in FIG. 2, when the insulating resin film 9 is provided not only between the positive collector exposed portion 8 and the negative active material containing layer 5 but also between the negative collector exposed portion 11 and the positive collector exposed portion 8, it is possible to prevent not only a short circuit between the positive collector 1 and the negative active material containing layer 5 but also between the positive collector 1 and the negative collector 4. As a result, safety can be further improved.

It is sufficient for the present invention that the insulating resin film is provided between the positive collector exposed portion and the negative active material containing layer in the state where the positive collector exposed portion is opposed to the negative active material containing layer with the separator therebetween. Thus, the present invention is not limited to the embodiment in which the insulating resin film is formed on the positive collector exposed portion as shown in FIG. 1. The insulating resin film may be formed on the negative active material containing layer opposed to the positive collector exposed portion, or on the separator interposed between the positive collector exposed portion and the negative active material containing layer. Further, as shown in FIG. 2, the insulating resin film 9 provided on the positive collector exposed portion 8 may cover the end portion of the positive active material containing layer 2.

The insulating resin film may be formed in the following manner, for example. A heat resistant resin is dissolved in a solvent that dissolves heat resistant resins but does not dissolve thermoplastic resins, and a thermoplastic resin is dispersed in the obtained solution to form a slurry. The slurry is applied to at least one of the positive collector exposed portion, the negative active material containing layer opposed to the positive collector exposed portion, and the separator interposed therebetween, followed by drying. As a result, the insulating resin film can be formed on the positive collector exposed portion, the negative active material containing layer opposed thereto, or the separator interposed therebetween.

There is no particular limitation on the solvent for use in the formation of the slurry. For example, when polyvinylidene fluoride is used as a heat resistant resin and polyethylene is used as a thermoplastic resin, a highly versatile solvent such as N-methylpyrrolidone may be used. The application of the slurry may be performed by any suitable means such as by using a die coater, a gravure coater, a reverse coater, a spray coater, or the like.

In order to improve the adhesion between the insulating resin film and the electrode or the separator, the insulating resin film may be heated up to a temperature at which the thermoplastic resin is deformed or melted by heat. Further, instead of heating, the insulating resin film may be pressed with a calendar roll or the like. A combination of heating and pressure further improves the adhesion between the insulating resin film and the electrode or the separator, and thus is preferable. In the case of heating, in order to achieve higher adhesion at a lower temperature, the thermoplastic resin for use in the insulating resin film preferably has a lower melting point than that of the heat resistant resin as a base substance.

The melting point of the heat resistant resin or the thermoplastic resin of the present invention refers to a melting temperature to be measured with a differential scanning calorimeter (DSC) according to the procedure of Japanese Industrial Standards (JIS) K 7121.

Next, a description will be given of other elements constituting the non-aqueous electrolyte battery of the present invention. The non-aqueous electrolyte battery of the present invention includes a primary battery and a secondary battery, but the following exemplary description is directed to a configuration of a secondary battery as a particularly major application thereof.

There is no particular limitation on the positive electrode, and those used in conventional non-aqueous electrolyte batteries are available. Examples of the active material includes a lithium-containing transition metal oxide expressed as Li₁₊ₓMO₂ (−0.1≦x≦0.1; M is a transition metal element such as Co, Ni, Mn, Zr, and Ti, or Al, etc.), a lithium manganese oxide such as LiMn₂O₄, a lithium manganese complex oxide in which a part of Li or Mn of LiMn₂O₄ is replaced with another element (Mg, Ni, Co, Al, etc.), an olivine-type LiMPO₄ (M is Co, Ni, Mn, Fe, etc.), and the like. Specific examples of the lithium-containing transition metal oxide include sheet oxides such as Li₍₁₊ₐ₎Ni_{(1-x-y)}MnₓCo_{y}O₂(−0.1≦a≦0.1; 0≦x≦0.5; 0≦y≦0.5), LiMn_{1/3}Ni_{1/3}Co_{1/3}O₂, LiNi_{0.77}Co_{0.2}Al_{0.03}O₂, and the like.

The above-mentioned positive active material constitutes the positive active material containing layer with a well-known conductive assistant (e.g., a carbon material such as carbon black and graphite) or a binder such as polyvinylidene fluoride (PVDF) that is added as appropriate according to need, and this layer is provided on the collector of aluminum foil or the like, whereby the positive electrode is formed.

The positive collector may be made of plate-shaped punching metal or the like instead of metal foil of aluminum or the like. However, aluminum foil having a thickness of 10 to 30 μm usually is used preferably.

In order to extract an electric current from the battery, the tab for current collection is welded to the exposed portion of the collector to form a lead portion. Instead of connecting the tab of aluminum or the like afterwards, a part of the collector may be used as a lead portion.

There is no particular limitation on the negative electrode, and those used in conventional non-aqueous electrolyte batteries are available. Examples of the active material include carbon-based materials that can occlude and release lithium, such as graphite, pyrolytic carbons, cokes, glassy carbons, sintered organic polymer compounds, mesocarbon microbeads (MCMB), and carbon fibers, and mixtures of two or more of these materials. Further, a single metal such as Si, Sn, Ge, Bi, Sb, and In, an alloy thereof, an oxide thereof, a lithium-containing nitride, lithium metal, or a lithium-aluminum alloy also may be used as the negative active material. The negative active material containing layer obtained by adding as appropriate a conductive assistant (e.g., a carbon material such as carbon black) or a binder such as PVDF to such a negative active material is formed on the collector. Alternatively, the collector may be coated with a plating thin film of the above material.

When the negative electrode includes the collector, it may be made of copper or nickel foil, punching metal, a mesh, expanded metal, or the like, and usually is made of copper foil. When a total thickness of the negative electrode is made small to provide a battery with a high energy density, the negative collector preferably has a maximum thickness of 30 μm and desirably has a minimum thickness of 5 μm. Further, a lead portion on a negative electrode side also may be formed in the same manner as the lead portion on the positive electrode side.

Preferable examples of a non-aqueous electrolyte include electrolyte solutions prepared by dissolving at least one lithium salt selected from LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCnF₂ₙ₊₁SO₃ (n≧2), LiN(RfOSO₂)₂ (where Rf is a fluoroalkyl group), and the like in at least one organic solvent selected from dimethyl carbonate, diethyl carbonate, methyl ethyl carbonate, methyl propionate, ethylene carbonate, propylene carbonate, butylene carbonate, γ-butyrolactone, ethylene glycol sulfite, 1,2-dimethoxyethane, 1,3-dioxolane, tetrahydrofuran, 2-methyl-tetrahydrofuran, diethyl ether, and the like, and electrolytes obtained by gelling the above electrolyte solution with a gelling agent. The concentration of a lithium salt contained in the electrolyte solution is preferably 0.5 to 1.5 mol/L, and more preferably 0.9 to 1.25 mol/L.

The non-aqueous electrolyte battery of the present invention may be a rectangular battery or a cylindrical battery using a steel can or an aluminum can as an outer shell, or a soft-package battery using a metal deposited laminated film as an outer shell.

Hereinafter, the present invention will be described in detail with reference to examples. However, each of the examples does not limit the present invention and can be varied as appropriate within the scope of the invention.

### EXAMPLE 1

In the present example, members corresponding to those in the configuration of the winding body in FIG. 1 are described with the same reference numerals given thereto.

[Production of Positive Electrode]

80 parts by mass of LiCoO₂ as a positive active material, 10 parts by mass of acetylene black as a conductive assistant, and 5 parts by mass of PVDF as a binder were mixed uniformly in a solvent of N-methyl-2-pyrrolidone (NMP) to prepare a paste containing a positive electrode mixture. The paste containing a positive electrode mixture was applied intermittently to both surfaces of aluminum foil (thickness: 15 μm) to be the positive collector 1, such that the applied active material was 281 mm long on a front surface and 212 mm long on a back surface (the positive collector exposed portion 8 was 69 mm long), followed by drying. Thereafter, the positive active material containing layer 2 was adjusted to have a total thickness of 150 μm by calendar processing and cut to a width of 43 mm, thereby producing the positive electrode 3 with a length of 281 mm and a width of 43 mm. Further, the positive electrode tab 10 made of aluminum was welded to the positive collector exposed portion 8 of the positive electrode 3.

[Formation of Insulating Resin Film]

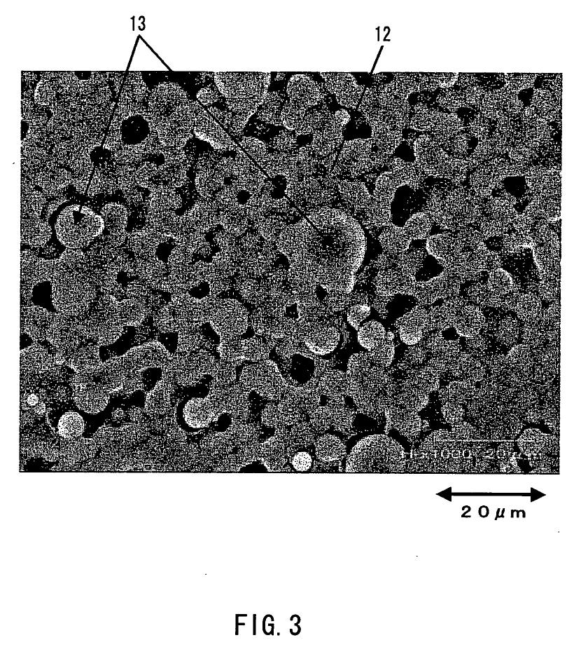

100 g of a NMP solution of PVDF as a heat resistant resin (solid concentration: 12 wt %) and 1.3 g of a polyethylene (PE) powder (average particle diameter: 6 μm) as a thermoplastic resin (ratio of PE to a total weight of PVDF and PE: 10 wt %) were charged in a vessel and stirred for 1 hour with a dispersing machine at 2800 rpm to form a slurry. The slurry was applied to the positive collector exposed portion 8 by using a die coater with a gap of 90 μm, followed by drying. As a result, the insulating resin film 9 with a thickness of 15 μm was formed. The application was performed so that the slurry was 10 mm long in a longitudinal direction of the positive electrode 3 with an edge of the positive active material containing layer 2 as one end. An electron micrograph (SEM image) of a surface of the insulating resin film 9 is shown in FIG. 3. As is evident from FIG. 3, the insulating resin film 9 has a structure in which the thermoplastic resin 13 is dispersed in the heat resistant resin 12 as a base substance such that the thermoplastic resin 13 has its surface covered with the heat resistant resin 12.

[Production of Negative Electrode]

90 parts by mass of graphite as a negative active material and 5 parts by mass of PVDF as a binder were mixed uniformly in a solvent of NMP to prepare a paste containing a negative material mixture. The paste containing a negative material mixture was applied intermittently to both surfaces of the negative collector 4 of copper foil (thickness: 10 μm), such that the applied active material was 287 mm long on a front surface and 228 mm long on a back surface (the negative collector exposed portion was 59 mm long), followed by drying. Thereafter, the negative active material containing layer 5 was adjusted to have a total thickness of 142 μm by calendar processing and cut to a width of 45 mm, thereby producing the negative electrode 6 with a length of 287 mm and a width of 45 mm. Further, the negative electrode tab made of copper was welded to the negative collector exposed portion of the negative electrode 6.

Then, as shown in FIG. 1, the separator 7 formed of a microporous film of polyethylene was interposed between the positive electrode 3 on which the insulating resin film 9 was formed and the negative electrode 6, thereby producing the winding body. Finally, the winding body was inserted into a metal can, and an electrolyte solution was injected thereinto, followed by sealing. In this manner, a non-aqueous electrolyte secondary battery was assembled.

### EXAMPLE 2

The positive electrode was produced in the same manner as in Example 1, except that 3 g of a polyethylene powder (ratio of PE to a total weight of PVDF and PE: 20 wt %) was used, and a non-aqueous electrolyte secondary battery was assembled.

### EXAMPLE 3

The positive electrode was produced in the same manner as in Example 1, except that 5.14 g of a polyethylene powder (ratio of PE to a total weight of PVDF and PE: 30 wt %) was used, and a non-aqueous electrolyte secondary battery was assembled.

### EXAMPLE 4

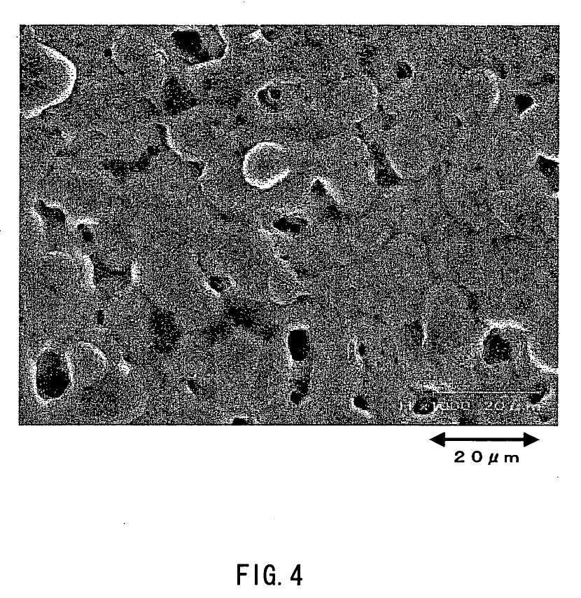

The positive electrode was produced in the same manner as in Example 1, except that the formed insulating resin film further was heated at 120° C. for 3 minutes so as to improve the adhesion between the insulating resin film and the positive collector exposed portion, and a non-aqueous electrolyte secondary battery was assembled. An electron micrograph (SEM image) of a surface of the heat-treated insulating resin film is shown in FIG. 4. As is evident from FIG. 4, in this insulating resin film, PVDF and polyethylene changed shape, and it became difficult to distinguish therebetween as compared with those in the insulating resin film shown in FIG. 3 that was not subjected to the heat treatment. However, this insulating resin film maintained the configuration in which polyethylene was dispersed in the base substance of PVDF.

### EXAMPLE 5

The positive electrode was produced in the same manner as in Example 1, except that a solution obtained by dissolving 12 g of a polyphenyl sulfone resin (PPS) as a heat resistant resin in 88 g of NMP was used instead of a NMP solution of PVDF, and a non-aqueous electrolyte secondary battery was assembled. The ratio of PE to a total weight of PPS and PE was 10 wt %.

### EXAMPLE 6

The positive electrode was produced in the same manner as in Example 1, except that 1.3 g of a polypropylene (PP) powder (average particle diameter: 6 μm) (ratio of PP to a total weight of PVDF and PP: 10 wt %) was used instead of a polyethylene powder, and a non-aqueous electrolyte secondary battery was assembled.

### EXAMPLE 7

The positive electrode was produced in the same manner as in Example 6, except that the formed insulating resin film further was pressed with a calendar roll heated to 130° C. so as to improve the adhesion between the insulating resin film and the positive collector exposed portion, and a non-aqueous electrolyte secondary battery was assembled.

### EXAMPLE 8

The positive electrode was produced in the same manner as in Example 1, except that 1.3 g of a cross-linked polymethyl methacrylate (cross-linked PMMA) powder (ratio of cross-linked PMMA to a total weight of PVDF and cross-linked PMMA: 10 wt %) was used instead of a polyethylene powder, and a non-aqueous electrolyte secondary battery was assembled.

### EXAMPLE 9

The positive electrode was produced in the same manner as in Example 1, except that 92 g of a NMP solution of carboxylic acid-modified PVDF (solid concentration: 13 wt %) was used instead of a NMP solution of PVDF, and that 6 g of a cross-linked polymethyl methacrylate powder (ratio of cross-linked PMMA to a total weight of PVDF and cross-linked PMMA: 33 wt %) was used instead of a polyethylene powder, and a non-aqueous electrolyte secondary battery was assembled.

### EXAMPLE 10

The positive electrode was produced in the same manner as in Example 9, except that 12 g of a cross-linked polymethyl methacrylate powder (ratio of cross-linked PMMA to a total weight of PVDF and cross-linked PMMA: 50 wt %) was used, and a non-aqueous electrolyte secondary battery was assembled.

### EXAMPLE 11

The positive electrode was produced in the same manner as in Example 9, except that 24 g of a cross-linked polymethyl methacrylate powder (ratio of cross-linked PMMA to a total weight of PVDF and cross-linked PMMA: 67 wt %) was used, and a non-aqueous electrolyte secondary battery was assembled.

### EXAMPLE 12

The positive electrode was produced in the same manner as in Example 9, except that 24 g of a cross-linked polymethyl methacrylate powder and 0.4 g of a polyethylene powder (ratio of cross-linked PMMA to a total weight of PVDF, cross-linked PMMA, and PE: 66 wt %; ratio of PE thereto: 1 wt %) were used, and a non-aqueous electrolyte secondary battery was assembled.

### COMPARATIVE EXAMPLE 1

The positive electrode was produced in the same manner as in Example 1, except that a polyethylene power was not used. As a result, the insulating resin film peeled off from the positive collector after drying. A non-aqueous electrolyte secondary battery was assembled using the positive electrode from which the insulating resin film was peeled off.

### COMPARATIVE EXAMPLE 2

The positive electrode was produced in the same manner as in Example 1, except that the insulating resin film was not formed on the positive collector exposed portion, and a non-aqueous electrolyte secondary battery was assembled.

Each of the non-aqueous electrolyte secondary batteries produced in Examples 1 to 12 and Comparative Examples 1 and 2 was evaluated for the following characteristics.

[Evaluation of Adhesion of Insulating Resin Film]

Each of the non-aqueous electrolyte secondary batteries produced in Examples 1 to 12 and Comparative Examples 1 and 2 was disassembled, and the degree of peeling-off of the insulating resin film from the positive collector was observed visually. The adhesion of the insulating resin film was evaluated as follows: A: particularly favorable; B: favorable; C: problematic.

[Short Circuit Test of Battery]

10 non-aqueous electrolyte secondary batteries of each of Examples 1 to 12 and Comparative Examples 1 and 2 were dropped onto a concrete floor from a height of 1.7 m 100 times, and the occurrence of an internal short circuit was examined. When a voltage reduction was seen in even 1 of the 10 batteries, they were evaluated as C. Batteries that remained the same were evaluated as B.

The results of the evaluations of each of the non-aqueous electrolyte secondary batteries were shown in Table 1.

TABLE 1

| | | Thermoplastic resin | | | | | |
|---|---|---|---|---|---|---|---|
| | Heat | and ratio thereof | | | | | |
| | resistant | Thermoplastic | | Heat | Pressure | | Short |
| | resin | resin | Wt % | treatment | treatment | Adhesion | circuit |
| Ex. 1 | PVDF | PE | 10 | No | No | B | B |
| Ex. 2 | PVDF | PE | 20 | No | No | B | B |
| Ex. 3 | PVDF | PE | 30 | No | No | B | B |
| Ex. 4 | PVDF | PE | 10 | 120° C. | No | A | B |
| Ex. 5 | PPS | PE | 10 | No | No | B | B |
| Ex. 6 | PVDF | PP | 10 | No | No | B | B |
| Ex. 7 | PVDF | PP | 10 | 130° C. | Treated | A | B |
| Ex. 8 | PVDF | Cross-linked | 10 | No | No | B | B |
| | | PMMA | | | | | |
| Ex. 9 | Carboxylic | Cross-linked | 33 | No | No | B | B |
| | acid-modified | PMMA | | | | | |
| | PVDF | | | | | | |
| Ex. 10 | Carboxylic | Cross-linked | 50 | No | No | B | B |
| | acid-modified | PMMA | | | | | |
| | PVDF | | | | | | |
| Ex. 11 | Carboxylic | Cross-linked | 67 | No | No | B | B |
| | acid-modified | PMMA | | | | | |
| | PVDF | | | | | | |
| Ex. 12 | Carboxylic | Cross-linked | 66 | No | No | A | B |
| | acid-modified | PMMA | | | | | |
| | PVDF | PE | 1 | | | | |
| Comp. | PVDF | — | 0 | No | No | C | C |
| Ex. 1 | | | | | | | |
| Comp. | — | — | — | — | — | — | C |
| Ex. 2 | | | | | | | |

As can be seen from the results in Table 1, the non-aqueous electrolyte secondary batteries in Examples 1 to 12 of the present invention exhibited enhanced adhesion of the insulating resin film to the positive collector than the non-aqueous electrolyte secondary battery in Comparative Example 1 in which the insulating resin film was formed only of PVDF, and achieved higher safety than the non-aqueous electrolyte secondary battery in Comparative Example 1 as well as the battery in Comparative Example 2 in which no insulating resin film was formed.

[Peeling Test]

In addition to the above evaluations, the following peeling test was conducted to check the suitability of the electrode for heat treatment.

An insulating resin film of a composition shown in Table 2 was formed on a surface of aluminum foil (thickness: 15 μm) to have a thickness of 15 μm, thereby producing a test piece. Two test pieces were prepared for an insulating resin film of each composition, and they were opposed to each other so that insulating resin film sides of the respective test pieces overlapped each other, followed by heat treatment. Then, it was examined whether the insulating resin films were peeled off easily from each other. The test pieces with their insulating film sides overlapping each other were sandwiched between two glasses and heated under the conditions of a pressure of 200 N and a temperature of 120° C. for 15 hours, followed by cooling to ambient temperature. When the insulating resin films were peeled off from each other with no resistance, they were evaluated as B1. When the insulating resin films were slightly resistant to being peeled off, they were evaluated as B2. Insulating resin films that are peeled off easily from each other do not cause a problem that the insulating resin films are adhered newly to the active material containing layer or the collector adjacent to the insulating resin films and it becomes impossible to separate the electrodes from each other, even when the insulating resin films are subjected to heat treatment in a state where the electrodes overlap each other. Therefore, such an insulating resin film is suitable for heat treatment of a produced long electrode that is wound in a so-called rolled state, and contributes to excellent mass productivity. Actually, a long positive electrode with the insulating resin film formed on the positive collector exposed portion was wound in a rolled state and subjected to heat treatment at 120° C. As a result, it was confirmed that the problem that the insulating resin film was adhered to the adjacent active material containing layer or the collector and was not peeled off did not occur.

TABLE 2

| | Thermoplastic resin | | |
|---|---|---|---|
| | and ratio thereof | | |
| Heat resistant | Thermoplastic | | |
| resin | resin | Wt % | Peelability |
| PVDF | PE | 5 | B1 |
| PVDF | PE | 10 | B1 |
| PVDF | PE | 20 | B2 |
| PVDF | PP | 10 | B1 |
| PVDF | Cross-linked | 10 | B1 |
| | PMMA | | |
| Carboxylic | Cross-linked | 33 | B1 |
| acid-modified | PMMA | | |
| PVDF | | | |
| Carboxylic | Cross-linked | 50 | B1 |
| acid-modified | PMMA | | |
| PVDF | | | |
| Carboxylic | Cross-linked | 67 | B1 |
| acid-modified | PMMA | | |
| PVDF | | | |
| Carboxylic | Cross-linked | 66 | B1 |
| acid-modified | PMMA | | |
| PVDF | PE | 1 | |

The insulating resin films containing 20 wt % of polyethylene were slightly resistant to being peeled off. This proved that when the electrode is subjected to heat treatment in a rolled state, it was preferable to include less than 20 wt % of polyethylene. On the other hand, it was found that the insulating resin films containing cross-linked PMMA were peeled off easily regardless of its ratio and thus were suitable for heat treatment. Further, the insulating resin films containing polypropylene were also peeled off easily regardless of its ratio, although only the result obtained by using 10 wt % of polypropylene was shown in Table 2.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A non-aqueous electrolyte battery comprising: a positive electrode including a positive collector and a positive active material containing layer formed on the positive collector;
a negative electrode including a negative collector and a negative active material containing layer formed on the negative collector; and
a separator provided between the positive electrode and the negative electrode,
wherein the positive electrode has a positive collector exposed portion at a part of the positive collector, on which the positive active material containing layer is not formed, and
an insulating resin film formed of a base substance of a heat resistant resin having a heat resistant temperature of 150° C. or more, the resin film containing a thermoplastic resin therein, is provided at a portion where the positive collector exposed portion and the negative active material containing layer are opposed to each other with the separator positioned therebetween.

2. The non-aqueous electrolyte battery according to claim 1, wherein the thermoplastic resin is dispersed in the insulating resin film.

3. The non-aqueous electrolyte battery according to claim 1, wherein the heat resistant resin has a melting point of 150° C. or more.

4. The non-aqueous electrolyte battery according to claim 1, wherein the positive collector is made of metal foil, and the heat resistant resin has a melting point lower than that of the metal foil.

5. The non-aqueous electrolyte battery according to claim 3, wherein the heat resistant resin is at least one selected from polyvinylidene fluoride and a derivative thereof.

6. The non-aqueous electrolyte battery according to claim 1, wherein the thermoplastic resin has a melting point lower than that of the heat resistant resin.

7. The non-aqueous electrolyte battery according to claim 1, wherein the thermoplastic resin is at least one selected from polyolefin, an ethylene-vinyl acetate copolymer, polymethyl methacrylate, an ethylene-methyl methacrylate copolymer, and derivatives thereof.

8. The non-aqueous electrolyte battery according to claim 1, wherein the thermoplastic resin is formed of substantially spherical particles.

9. The non-aqueous electrolyte battery according to claim 1, wherein the thermoplastic resin is present in the insulating resin film in an amount of not less than 1 wt % and not more than 80 wt % based on the total weight of the thermoplastic resin and the heat resistant resin.

10. The non-aqueous electrolyte battery according to claim 1, wherein the insulating resin film is adhered to at least one of the positive collector exposed portion, the negative electrode, and the separator.

11. The non-aqueous electrolyte battery according to claim 1, wherein the insulating resin film has a thickness of not less than 5 μm and not more than 30 μm.

12. The non-aqueous electrolyte battery according to claim 1,
wherein the negative electrode has a negative collector exposed portion at a part of the negative collector, on which the negative active material containing layer is not formed, and
the insulating resin film is provided at a portion where the negative collector exposed portion and the positive collector exposed portion are opposed to each other with the separator positioned therebetween.

13. A method for producing a non-aqueous electrolyte battery comprising: a positive electrode including a positive collector, a positive active material containing layer formed on the positive collector, and a positive collector exposed portion at a part of the positive collector, on which the positive active material containing layer is not formed;
a negative electrode including a negative collector and a negative active material containing layer formed on the negative collector; and
a separator provided between the positive electrode and the negative electrode, the method comprising:
dissolving a heat resistant resin having a heat resistant temperature of 150° C. or more in a solvent to form a solution of said heat resistant resin in said solvent;
dispersing a thermoplastic resin in said solution in which the heat resistant resin is dissolved to form a slurry; and
applying the slurry to at least one of the positive collector exposed portion, the negative electrode, and the separator, followed by drying,
wherein an insulating resin film formed of a base substance of a heat resistant resin having a heat resistant temperature of 150° C. or more, the resin film containing a thermoplastic resin therein, is provided at a portion where the positive collector exposed portion and the negative active material containing layer are opposed to each other with the separator positioned therebetween.

14. The method for producing a non-aqueous electrolyte battery according to claim 13, further comprising: heating the insulating resin film to adhere the insulating resin film to at least one of the positive collector exposed portion, the negative electrode, and the separator.

15. The method for producing a non-aqueous electrolyte battery according to claim 13, further comprising: heating and pressing the insulating resin film to adhere the insulating resin film to at least one of the positive collector exposed portion, the negative electrode, and the separator.

16. The method for producing a non-aqueous electrolyte battery according to claim 13, wherein the thermoplastic resin has a melting point lower than that of the heat resistant resin.
